(19) United States
(12) Patent Application Publication
(10) Pub. No.: US 2015/0232364 A1
(43) Pub. Date: Aug. 20, 2015

(54) APPARATUS FOR MANUFACTURING A GLASS MOLDING AND METHOD FOR MANUFACTURING A GLASS MOLDING

(71) Applicant: HOYA CORPORATION, Tokyo (JP)

(72) Inventors: Tadayuki Fujimoto, Tokyo (JP); Kiyokane Yamazaki, Tokyo (JP)

(21) Appl. No.: 14/427,165

(22) PCT Filed: Sep. 10, 2013
(86) PCT No.: PCT/JP2013/074369

§ 371 Date: Mar. 10, 2015

(30) Foreign Application Priority Data
Sep. 10, 2012 (JP) 2012-198257

(51) Int. Cl. C03B 11/02; C03B 11/16; C03B 35/00; C03B 11/12

(52) U.S. Cl. CPC C03B 11/02; C03B 11/122; C03B 11/16; C03B 35/005; C03B 2215/46

(57) ABSTRACT

Provided is an apparatus for glass molding. An apparatus for a glass molding includes: a conveyance section including a turntable turned while holding a mold unit; a molding section to press molding; a replacement section and a preheating section for replacement between the mold unit and a new mold unit, and heating of the glass material disposed inside the new mold unit, wherein the molding section, the replacement section and the preheating section are in adjacent relation to the conveyance section at positions in a circumferential direction about a rotary shaft of the turntable, and wherein the glass molding apparatus includes: a molding section displacement mechanism for displacing the mold unit between the molding section and the conveyance section; and a replacement section displacement mechanism and a preheating section displacement mechanism for displacing the mold unit between the replacement section and the preheating section, and the conveyance section.

### TECHNICAL FIELD

The present invention relates to an apparatus for manufacturing a glass molding and method for manufacturing a glass molding, and particularly to an apparatus and method for molding a glass material by heating the glass material disposed inside a mold and pressing this glass material.

### BACKGROUND ART

In recent years, there has been employed a method for forming a glass molding such as a lens by disposing a glass material inside a mold; heating the glass material and the mold; and pressing the softened glass material using a mold. As an apparatus for manufacturing a glass molding by press molding in the above manner, Patent Document 1 (JP 63-170225 A), for example, discloses a molding apparatus in which a pressing mechanism is installed inside a molding section, and a heating coil is installed around an outer periphery of the molding section.

As another example, Patent Document 2 (JP 1-157425 A) discloses an apparatus in which operation chambers such as a heating chamber, a pressing chamber and a cooling chamber, are continuously arranged in a circumferential direction on a turntable, and molds containing a glass material is sequentially conveyed through these chambers by a turntable, thereby heating (preheating), press molding and cooling the glass material to manufacture a glass molding.

### CITATION LIST

### Patent Document

Patent Document 1: JP 63-170225 A

Patent Document 2: JP 1-157425 A

### SUMMARY OF INVENTION

### Technical Problem

However, the apparatus described in the Patent Document 1 (JP 63-170225 A) is unsuitable for mass production of a lens, because it is not assumed to manufacture a plurality of lenses in parallel by a flow process.

In a manufacturing process of a glass molding, a press forming step is highly time-consuming, as compared to a preheating step, a cooling step, and a mold taking-out and taking-in step. Thus, in the case where it is attempted to manufacture glass moldings by using a plurality of molds in the apparatus described in the Patent Document 2, even if such as the preheating step has been completed for one of the molds, the turntable cannot be turned until the press molding step for the other molds is completed. That is, during a time period where one of the molds is subjected to the press molding step, even if the preheating step has been completed for the other molds, it cannot be subjected to a next step. Therefore, under the influence of the time required for the press molding step for other mold, a time of the entire glass molding manufacturing process is extended, resulting in deterioration in productivity.

The present invention has been made in view of the above problems, and an object thereof is to provide a highly-productive glass molding apparatus and method.

### Solution to Technical Problem

An apparatus for manufacturing a glass molding according to the present invention by heating a glass material disposed inside a mold unit and subjecting the heated glass material to press molding, comprises: a conveyance section including a turntable turning with holding the mold unit; a main operation section for performing at least press molding the glass material disposed inside the mold unit; and a sub-operation section for performing an operation which is different from that in the main operation section and includes replacement between the mold unit after completion of the press molding and a new mold unit, or replacement between a glass molding molded from the mold unit after completion of the press molding and a glass material, and heating of the glass material disposed inside the new mold unit, wherein the main operation section and the sub-operation section are provided in adjacent relation to the conveyance section at respective positions apart from each other in a circumferential direction about a rotary shaft of the turntable, and wherein the glass molding manufacturing apparatus further comprises: a main displacement mechanism for displacing the mold unit between the main operation section and the conveyance section; and a sub-displacement mechanism for displacing the mold unit between the sub-operation section and the conveyance section.

According to the apparatus for manufacturing glass molding of the present invention, the replacement of a mold unit and the heating of a glass material can be performed in the sub-operation section, so that, in the case where the manufacture of glass molded molds are performed using a plurality of mold units, even when one of the mold units is positioned inside the main operation section, the replacement of another mold unit and the heating of a glass material can be concurrently and continuously performed in the sub-operation section. This makes it possible to enhance productivity of glass moldings.

A method for manufacturing glass molding according to the present invention using an apparatus for manufacturing glass molding, wherein the glass molding manufacturing apparatus comprises: a conveyance section housing a turntable; a main operation section for press molding a glass material disposed inside a mold unit and a sub-operation section for performing an operation which is different from that in the main operation section and includes replacement between the mold unit after completion of the press molding and a new mold unit, or replacement between a glass molding molded from the mold unit after completion of the press molding and a glass material, and heating of the glass material disposed inside the new mold unit, wherein the main operation section and the sub-operation section are provided in adjacent relation to the conveyance section at respective positions apart from each other in a circumferential direction about a rotary shaft of the turntable, and wherein the glass molding manufacturing apparatus further comprises: a main displacement mechanism for displacing the mold unit between the main operation section and the conveyance section; and a sub-displacement mechanism for displacing the mold unit between the sub-operation section and the conveyance section, the manufacturing method comprises: a replacement step of performing by the sub-operation section the replacement between the mold unit after completion of the press molding and a new mold unit, or replacement between a glass molding molded from the mold unit after completion of the press molding and a glass material; a preheating step of preheating by the sub-operation section the glass material disposed inside the mold unit; a sub-main displacement step of: displacing by the sub-displacement mechanism the mold unit from the sub-operation section to the conveyance section; turningly displacing by the turntable the mold unit through the conveyance section; and displacing by the main displacement mechanism the mold unit from the conveyance section to the main operation section; a molding step of press molding the glass material by the main-operation section; and a main-sub displacement step of: displacing by the main displacement mechanism the mold unit from the main operation section to the conveyance section; turningly displacing by the turntable the mold unit through the conveyance section; and displacing by the sub-displacement mechanism the mold unit from the conveyance section to the sub-operation section, wherein, while the molding step is performed to one mold unit, at least a part of one of the replacement step and the preheating step is concurrently performed to another mold unit.

According to the method of manufacturing glass molding of the present invention, while the molding step is performed for one mold unit in the main operation section, the replacement and the heating of a glass material for another mold unit can be concurrently performed in the sub-operation section. This makes it possible to enhance productivity of glass moldings.

### Effect of Invention

According to the present invention, a highly-productive apparatus for glass molding and method for manufacturing the same can be provided.

### BRIEF DESCRIPTION OF DRAWINGS

FIG. 1 is a perspective schematic view illustrating a configuration of a lens molding apparatus according to a first embodiment.

FIG. 2 is a horizontal sectional view at a height of a conveyance section, illustrating the configuration of the lens molding apparatus according to the first embodiment.

F1G. 3 is a horizontal sectional view at a height of a preheating section, a molding section and a replacement section, illustrating the configuration of the lens molding apparatus according to the first embodiment.

FIG. 4 is a sectional view along the line A-A′ in FIG. 3, illustrating the configuration of the lens molding apparatus according to the first embodiment.

FIG. 5 is a sectional view taken along the line B-B′ in FIG. 3, illustrating the configuration of the lens molding apparatus according to the first embodiment.

FIG. 6 is a vertical sectional view illustrating a configuration of a mold unit used in the first embodiment.

FIG. 7 is a diagram illustrating a horizontal position (I) of a mold support member, for explaining a lens molding method according to the first embodiment.

FIG. 8 is a sectional view along the line B-B′ in FIG. 7, for explaining the lens molding method according to the first embodiment.

FIG. 9 is a diagram illustrating a horizontal position (II) of the mold support member, for explaining the lens molding method according to the first embodiment.

FIG. 10 is a sectional view along the line B-B′ in FIG. 9, for explaining the glass molding manufacturing method according to the first embodiment.

FIG. 11 is a diagram illustrating a horizontal position (III) of the mold support member, for explaining the lens molding method according to the first embodiment.

FIG. 12 is a sectional view along the line B-B′ in FIG. 11, for explaining the lens molding method according to in the first embodiment.

FIG. 13 is a diagram illustrating a horizontal position (IV) of the mold support member, for explaining the lens molding method according to the first embodiment.

FIG. 14 is a sectional view taken along the line B-B′ in FIG. 13, for explaining the lens molding method according to the first embodiment.

FIG. 15 is a diagram illustrating a horizontal position (V) of the mold support member, for explaining the lens molding method according to the first embodiment.

FIG. 16 is a sectional view taken along the line B-B′ in FIG. 15, for explaining the method according to the first embodiment.

FIG. 17 is a graph presenting a temporal history of a temperature of a glass material disposed inside a mold attached to one mold support member in the lens molding method according to the first embodiment.

FIG. 18 is a chart presenting a flow of a process performed for a pair of mold units in the lens molding method according to the first embodiment.

FIG. 19 is a perspective schematic view illustrating a configuration of a lens molding apparatus according to a second embodiment of the present invention.

FIG. 20 is a horizontal sectional view at a height position of a conveyance section, illustrating the configuration of the lens molding apparatus according to the second embodiment.

FIG. 21 is a horizontal sectional view at a height position of a preheating and replacement section and a molding section, illustrating the configuration of the glass lens molding apparatus according to the second embodiment.

FIG. 22 is a sectional view taken along the line A-A′ in F1G. 21.

FIG. 23 is a chart presenting a flow of a process performed for a pair of mold units in the lens molding apparatus according to the second embodiment.

### DESCRIPTION OF EMBODIMENTS

With reference to the drawings, preferred embodiments of the present invention will now be described in detailed. In the embodiments, the same or equivalent elements or components are assigned with the same reference sign, and description thereof will not be repeated.

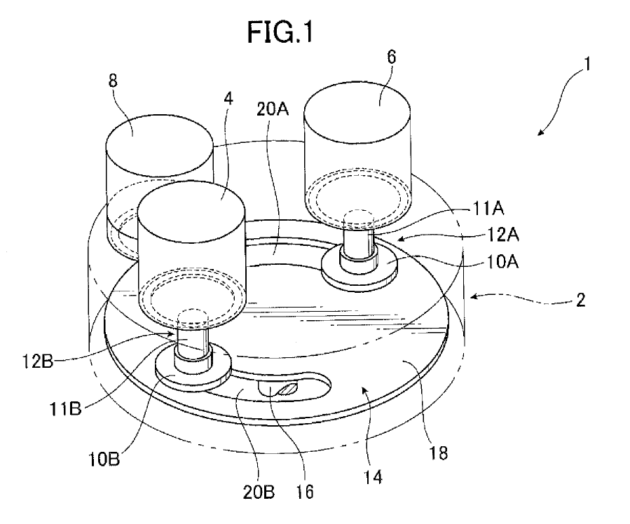

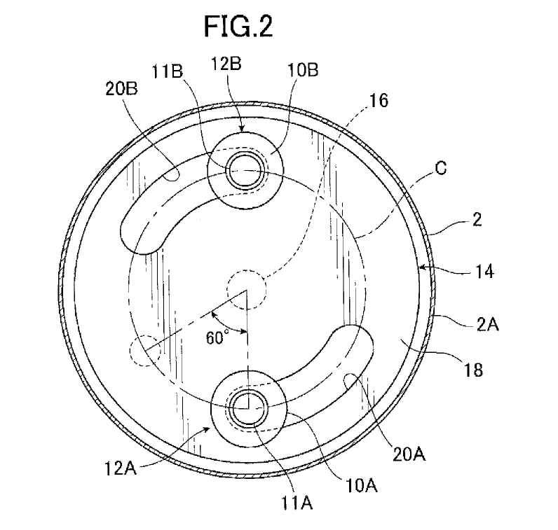

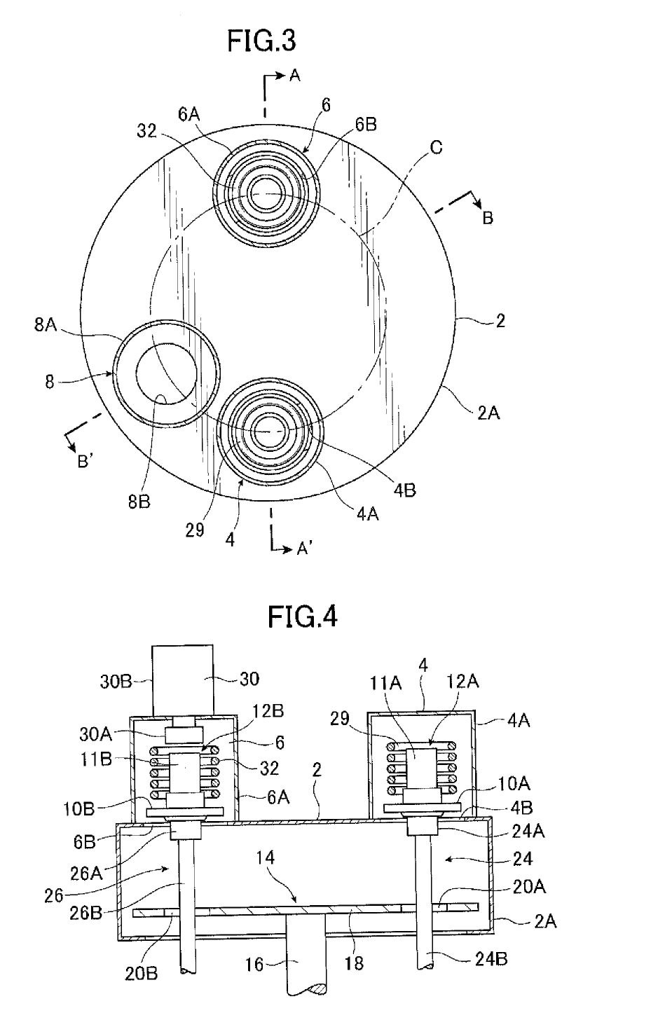

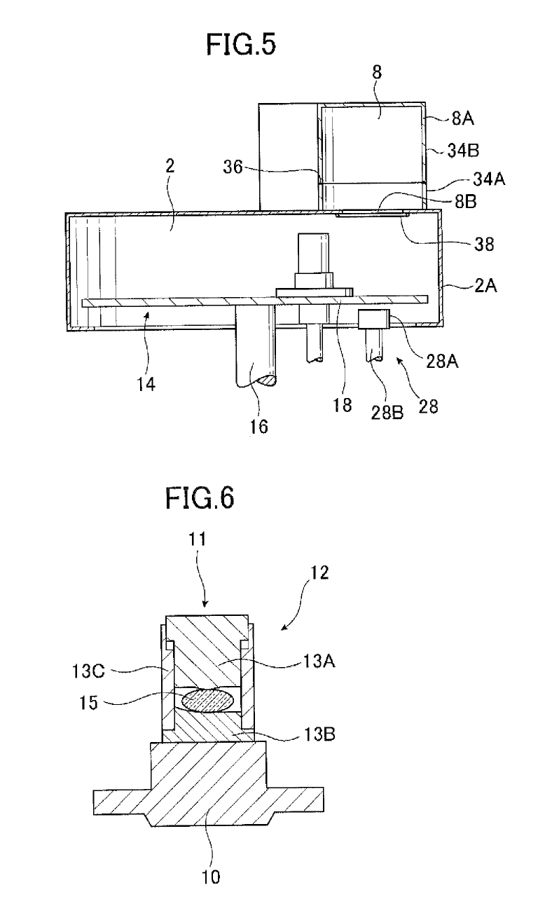

FIGS. 1 to 5 illustrate a configuration of a lens molding apparatus according to a first embodiment of the present invention, wherein FIG. 1 is a perspective schematic view, FIG. 2 is a horizontal sectional view at a height position of a conveyance section, and FIG. 3 is a horizontal sectional view at a height position of a preheating section, a molding section and a replacement section. FIG. 4 is a sectional view along the line A-A′ in FIG. 3, and FIG. 5 is a sectional view along the line B-B′ in FIG. 3. In FIG. 1, for the sake of illustration, the conveyance section is indicated by a dashed line. Further, FIG. 6 is a vertical sectional view illustrating a configuration of a mold unit 12 used in the lens molding apparatus according to the first embodiment.

As illustrated in these figures, the lens molding apparatus 1 according to the first embodiment comprises an approximately columnar-shaped conveyance section (conveyance chamber) 2, a preheating section (preheating chamber) 4, a molding section (molding chamber) 6, and a replacement section (replacement chamber) 8. In a lens molding method according to the first embodiment, a glass material is molded by performing each steps while displacing a pair of mold units 12A, 12B each comprising a mold support member 10A, 10B on which a mold 11A, 11B is placed, sequentially to the preheating section 4, the molding section 6 and the replacement section 8 via the conveyance section 2.

The preheating section 4, the molding section 6 and the replacement section 8 are arranged along a circumference of a small circle C (see FIG. 2) having a given radius less than an outer radius of a turntable 14 mentioned below, i.e., arranged such that respective centers of the preheating section 4, the molding section 6 and the replacement section 8 are located on the small circle C. The preheating section 4 and the molding section 6 are provided on approximately radially opposite sides with respect to a rotary shaft 16 of the turntable 14. The replacement section 8 is provided, in top plan view, at a position apart from the preheating section 4 by a rotation angle of 60° in a clockwise direction about the rotary shaft 16 (see FIGS. 4 and 5) of the turntable 14.

The conveyance section 2, in which a columnar-shaped spaced is defined by a conveyance section casing 2A, comprises: a turntable 14 installed in this space; and a preheating section displacement mechanism 24, a molding section displacement mechanism 26 and a replacement section displacement mechanism 28 each provided beneath a respective one of the preheating section 4, the molding section 6 and the replacement section 8. Openings 4B, 6B, 8B are formed on an upper wall of the conveyance section casing 2A at areas corresponding to the preheating section 4, the molding section 6 and the replacement section 8. The internal space of the conveyance section 2 communicates with each internal space of the preheating section 4, the molding section 6 and the replacement section 8 via these openings 4B, 6B, 8B. In this embodiment, the each diameter of the openings 4B, 6B formed between the conveyance section 2, and the preheating section 4 and the molding section 6 is greater than the diameters of the mold support members 10A, 10B. On the other hand, the diameter of the opening 8B formed between the conveyance section 2 and the replacement section 8 is less than the diameters of the mold support members 10A, 10B. Although, in this embodiment, the interior of the conveyance section 2 is not particularly be heated by a heater or the like, the present invention is not limited thereto, but the interior of the conveyance section 2 may be heated. The interior of each of the preheating section 4, the molding section 6 and the replacement section 8 is maintained in an inert gas atmosphere. It is preferable that nitrogen or argon is used as an inert gas, and an oxygen concentration is set to be equal to or less than 5 ppm. As a result of maintaining the interior of each of the preheating section 4, the molding section 6 and the replacement section 8 in an inert gas atmosphere, it is possible to prevent oxidization of the mold unit 12 and surface alteration of the glass material.

The turntable 14 comprises a rotary shaft 16 provided to extend upwardly from therebelow at the center of the conveyance section 2, and a circular plate-shaped turning disk 18 supported by the rotary shaft 16. A drive device (not illustrated), such as a motor, for rotationally driving the rotary shaft 16 is provided below the conveyance section 2. When the rotary shaft 16 is rotated by the drive device, the turning disk 18 is turned, so that the mold units 12A, 12B on the turning disk 18 are rotationally displaced. The turntable 14 can be rotated in clockwise and counterclockwise directions.

Two elongate holes 20A, 20B extending point-symmetrically in an arc pattern about the rotation shaft 16 is formed in the turning disk 18. Each of the elongate holes 20A, 20B is formed such that an arc passing through a widthwise center line thereof is located on the circumference of the small circle C about the rotary shaft 16. These elongate holes 20A, 20B also extend over an angular range about the rotary shaft 16, which is equal to an angle between the replacement section 8 and the preheating section 4 (i.e., in the first embodiment, 60°). The angle between the replacement section 8 and the preheating section 4 may be appropriately set to 45°, 90°, 120°, or any other angular range of less than 180°. The preheating section 4, the molding section 6 and the replacement section 8 are formed above the conveyance section 2, along the circumference of the small circle C passing through the widthwise center lines of the elongate holes 20A, 20B.

Each of the displacement mechanisms 24, 26, 28 comprises a drive shaft 24B, 26B, 28B extending in an up-down direction, and a holding member 24A, 26A, 28A attached to a distal end of the drive shaft 24B, 26B, 28B. The displacement mechanisms 24, 26, 28 are provided beneath and correspondingly to the preheating section 4, the molding section 6 and the replacement section 8, respectively. Each of the drive shafts 24B, 26B, 28B of the displacement mechanisms 24, 26, 28 is capable of being advanced and retracted in the up-down direction between a position where the holding member 24A, 26A, 28A is retracted downwardly so as to avoid interference with the turntable 14, and a position where the holding member 24A, 26A, 28A at the distal end of the drive shaft is advanced to penetrate through the elongate hole 20A, 20B and reach a lower end of the preheating section 4, the molding section 6 and the replacement section 8, by a drive device (not illustrated), such as an actuator, provided below the conveyance section 2. Thus, each of the displacement mechanisms 24, 26, 28 can displace the mold units 12A, 12B between a lower position where the mold unit is located on the turntable 14, and an upper position where the mold unit is received in a chamber of a corresponding one of the preheating section 4, the molding section 6 and the replacement section 8.

In addition, even in a situation where one of the mold units is positioned inside the molding section 6 by the molding section displacement mechanism 26, since the arc-shaped elongate holes 20A, 20B are formed in the turntable 14, the turntable 14 can be turned between the preheating section 4 and the replacement section 8.

The preheating section 4 is formed of an approximately circular cylindrical-shaped space defined by a preheating section casing 4A and comprises a heater 29 provided therein. As this heater 29, a type capable of uniformly heating a heating target (mold unit) disposed inward thereof, from the periphery of the heating target, e.g., a coil heater is preferable. The preheating section 4, in advance of the press molding of the glass material in the molding section 6, heats the mold unit up to a temperature around a glass-transition temperature Tg of the glass material. Preferably, the interior of the preheating section 4 is internally maintained in an inert gas atmosphere. Although the heater 29 is provided inside of the preheating section 4 in this embodiment, it is not limited thereto, but the heater may be mounted outside of the preheating section 4.

The molding section 6 is formed of preheating section 4 defined by a molding section casing 6B and comprises a pressing machine 30 and a heater 32. The pressing machine 30 comprises a pressing head 30A, and a pressing head drive unit 30B. An actuator such as a hydraulic piston is built in the pressing head drive unit 30B and the pressing head 30A is moved downwardly into the molding section 6 by driving the actuator. The heater 29 is provided to heat and softened the glass material disposed inside the mold unit 12. Similarly to the heater 29 of the molding section 6, it is desirable that the heater 29 of the preheating section 4 is a type capable of uniformly heating a heating target disposed inward thereof, from the side of an outer periphery of the heating target, e.g., a coil heater. Although the heater 32 is provided inside of the molding section 6 in this embodiment, it is not limited thereto, but it may be mounted outside of the molding section 6.

The replacement section 8 is formed of an approximately circular cylindrical-shaped space defined by a replacement section casing 8A. The replacement section casing 8A comprises a base casing 34A integrated with an upper portion of the conveyance section casing 2A, and an upper casing 34B disposed above the base casing 34A. An O-ring 36 is attached to an upper edge surface of the base casing 34A. Thus, when the upper casing 34B is coaxially placed on the base casing 34A, a region between the base casing 34A and the upper casing 34B is tightly sealed by the O-ring 36. An O-ring 38 is also attached to a region of the upper wall of the conveyance section casing 2A surrounding the opening 8B corresponding to the replacement section 8.

In this embodiment, the molding section 6 composes the main operation section for press molding the glass material disposed inside the mold unit. Further, the preheating section 4 and the replacement section 8 compose the sub-operation section for performing replacement between the mold unit after completion of the press molding and a new mold unit, and heating of the glass material disposed inside the new mold unit. The molding section displacement mechanism 26 composes the main displacement mechanism, and the preheating section displacement mechanism 24 and the replacement section displacement mechanism 28 compose the sub-displacement mechanism.

As illustrated in FIG. 6, the mold unit 12 (12A, 12B illustrated in FIG. 1) includes a mold 11 (11A, 11B illustrated in FIG. 1), and a mold support member 10 (10A, 10B illustrated in FIG. 1), wherein the mold 11 is attached to the mold support member 10. The mold 11 has an upper mold 13A and a lower mold 13B which have a molding surface formed in conformity to a shape of a glass molding to be manufactured; and a sleeve mold 13C for restricting radial mutual positions of the upper mold 13A and the lower mold 13B. A release film is formed on the molding surface of the upper mold 13A and the lower mold 13B. A glass material 15 is disposed in a condition where it being clamped between the upper mold 13A and the lower mold 13B. In the state where the glass material 15 is heated up to a glass-yielding temperature or more, a pressure is applied to the upper mold 13A and the lower mold 13B in a direction causing them to come closer to each other, so that a shape of the molding surface is transferred to the glass material, thereby press-molding the glass material into a glass molding (optical element) of a desired shape.

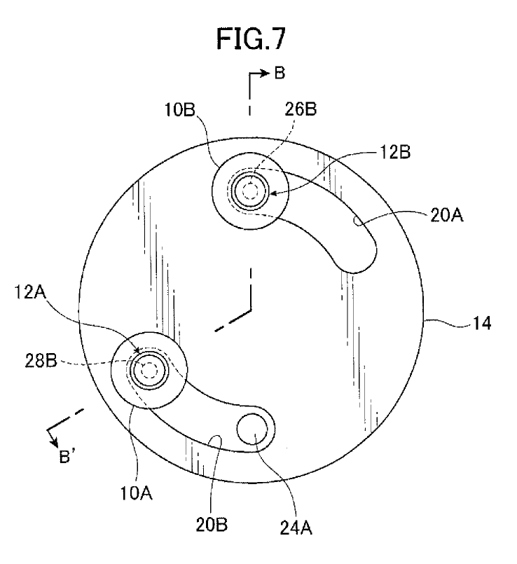

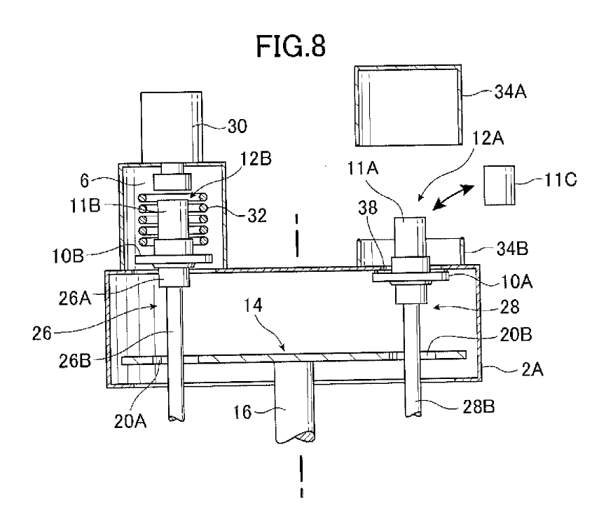

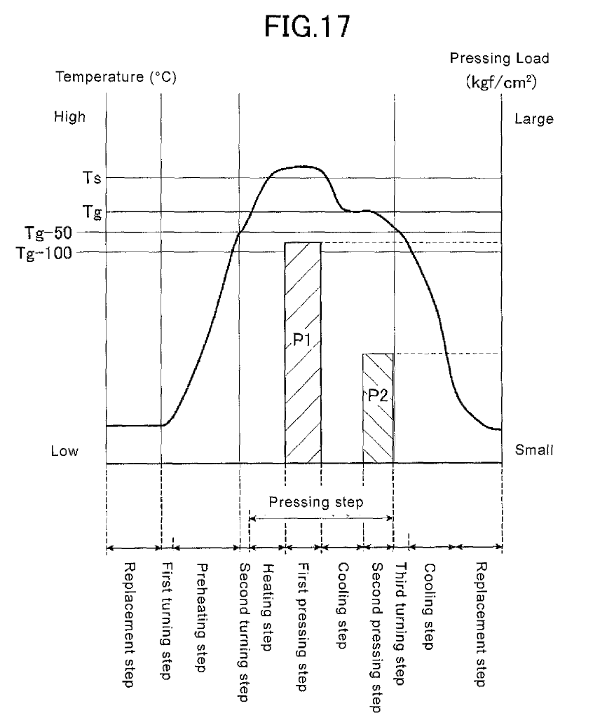

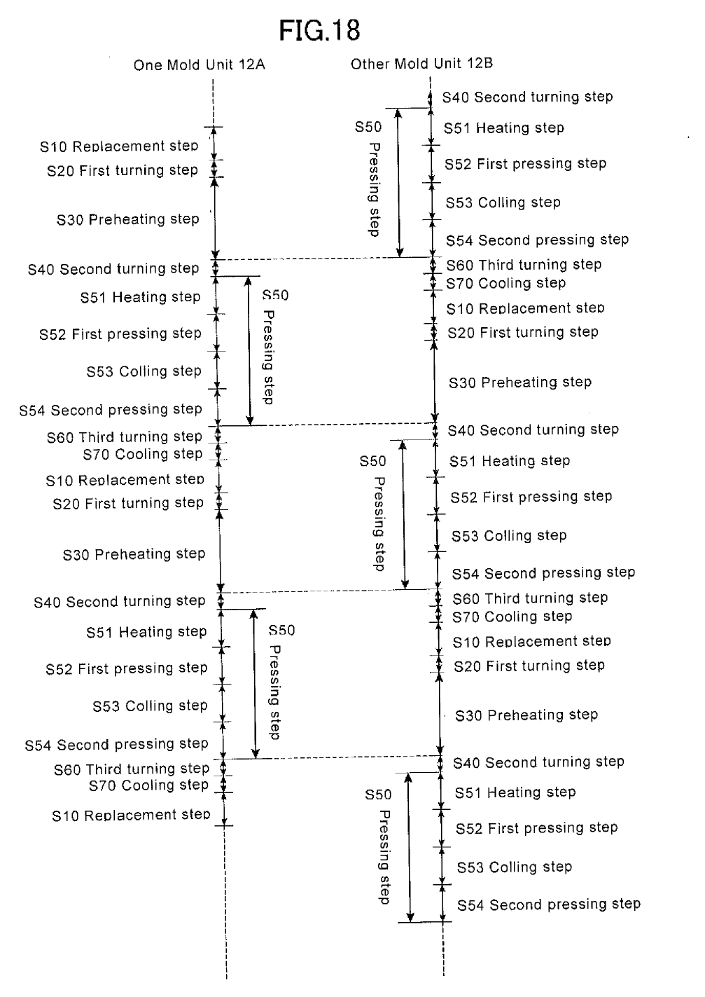

FIGS. 7 to 17 are diagrams for explaining a lens molding method in the first embodiment. FIGS. 7, 9, 11, 13 and 15 are diagrams illustrating horizontal positions of two mold support members in respective steps, and FIGS. 8, 10, 12, 14 and 16 are sectional views along the lines B-B′ in FIGS. 7, 9, 11, 13 and 15, respectively. FIG. 17 is a graph presenting a temporal history of a temperature of a glass material within a mold attached to one of the mold support members. FIG. 18 is a chart presenting a flow of a process to be performed with respect to the pair of mold units 12A, 12B.

With reference to FIGS. 7 to 17, a lens molding method using the above lens molding apparatus 1 will be described below.

The lens molding apparatus 1 according to the first embodiment performs two glass material molding operations in parallel with a timing delay between the operations.

The following description will be started from a state just after the one mold unit 12A is positioned inside the replacement section 8 after completion of molding of the glass material disposed inside the one mold 11A, and the other mold unit 12B is displaced to the molding section 6, as illustrated in FIGS. 7 and 8. In this state, the turntable 14 is in a position where the drive shaft 28B of the replacement section displacement mechanism 28 is located at a end of the one elongate hole 20B in the clockwise direction, and the drive shaft 26B of the molding section displacement mechanism 26 is located at a end of the other elongate hole 20A in the counterclockwise direction.

First of all, in this state, a replacement step S10 of replacing the mold 11A of the first mold unit 12A with a new one is performed in the replacement section 8. Specifically, the upper casing 34B of the replacement section 8 is first displaced upwardly. Then, a glass molding and the mold 11A after completion of the molding are detached from the one mold support member 10A, and a mold 11C, in which a new glass material is contained, is attached to the one mold support member 10A. The O-ring 38 is provided around the opening of the conveyance section casing 2A communicating with the replacement section 8, and thus, an upper surface of the one mold support member 10A is brought into contact with the O-ring 38. Therefore, even when the upper casing 34B of the replacement section 8 is detached, it becomes possible to maintain an inside of the conveyance section 2 in a gas-tight state to prevent an increase in oxygen (O₂) concentration.

Concurrently with this, a pressing step S50 (a heating step S51, a first pressing step S52, a cooling step S53 and a second pressing step S54) of pressing the mold 11B of the other mold unit 12B is performed in the molding section 6. Each steps of the pressing step S50 will be described in detail in connection with an operation of performing the pressing step S50 to the mold 11C of the first mold unit 12A.

Then, in a situation where the pressing step S50 is performed to the mold 11B of the other mold unit 12B, a first displacement step S20 of displacing the one mold unit 12A from the replacement section 8 to the preheating section 4 is performed. Specifically, the one mold unit 12A is displaced from an inside of the replacement section 8 to a position on the turn table 14 by the replacement section displacement mechanism 28. Then, the turntable 14 is turned until the one mold unit 12A is displaced to a position beneath the preheating section 4 (i.e., by 60° in the counterclockwise direction in top plan view). In this situation, the arc-shaped other elongate hole 20A is formed in the turntable 14 and the drive shaft 26B of the molding section displacement mechanism 26 holds the other mold unit 12B with penetrating through the arc-shaped other elongate hole 20A, so that the turntable 14 can be turned without interference between the turntable 14 and the drive shaft 26B. Then, the one mold unit 12A is displaced from the position on the turn table 14 to an inside of the preheating section 4 by the preheating section displacement mechanism 24. The first displacement step S20 corresponds to sub-sub displacement step.

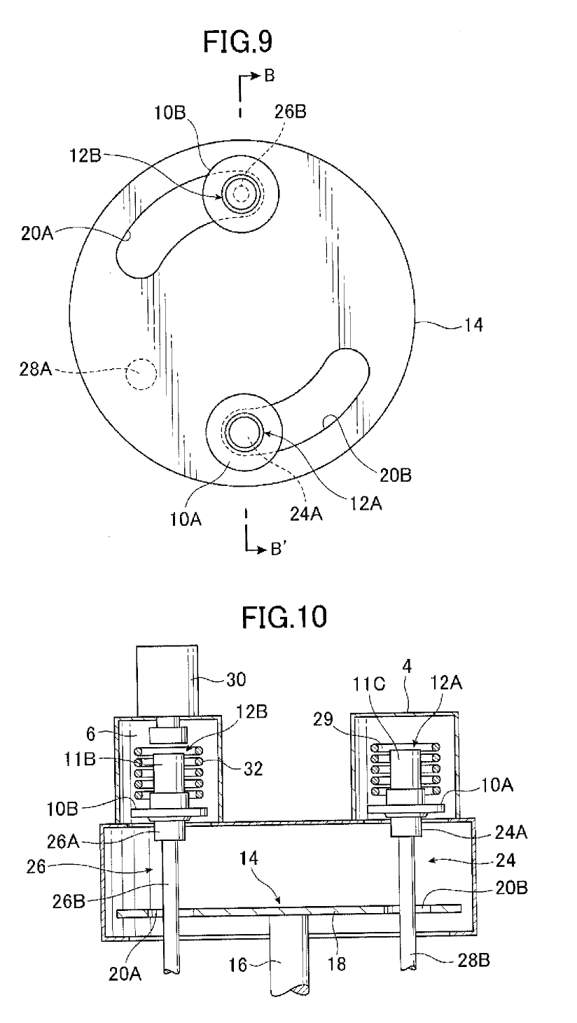

Then, as illustrated in FIGS. 9 and 10, in a situation where the pressing step S50 is performed to the mold 11B of the other mold unit 12B, a preheating step S30 is performed to the mold 11C of the one mold unit 12A. Specifically, the mold 11C is heated by the heater 29 in the preheating section 4. Preferably, in the preheating step, the heater 29 is controlled to prevent a temperature of the glass material disposed inside the mold 11C from exceeding the glass-transition temperature Tg+10° C., as illustrated in FIG. 17.

Then, after the completion of the pressing step S50 for the mold 11B of the other mold unit 12B is completed, a second displacement step S40 of displacing the one mold unit 12A from the preheating section 4 to the molding section 6 is performed. Concurrently with this, a third displacement step S60 of displacing the other mold unit 12B from the molding section 6 to the replacement section 8 is performed.

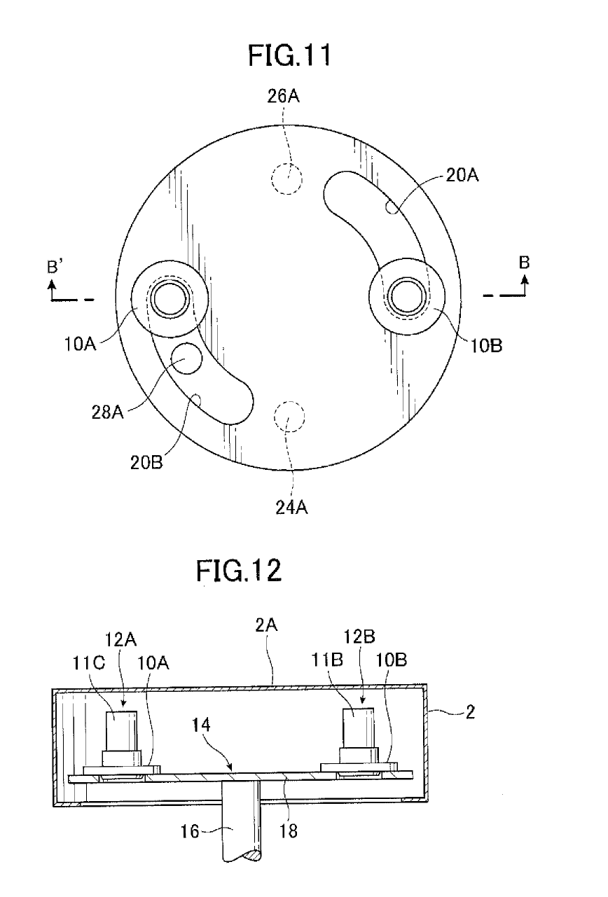

Specifically, the preheated one mold unit 12A is displaced from the inside of the preheating section 4 to a position on the turntable 14. Concurrently, the other mold unit 12B is displaced from the molding section 6 to a position on the turntable 14. Then, the turntable 14 is turned until the one mold unit 12A is displaced to a position beneath the molding section 6 (in the first embodiment, turned by 180°). FIGS. 11 and 12 illustrate a state in the course of turning in the second and third displacement steps (a state when the turntable 14 is turned in the clockwise direction by 90°).

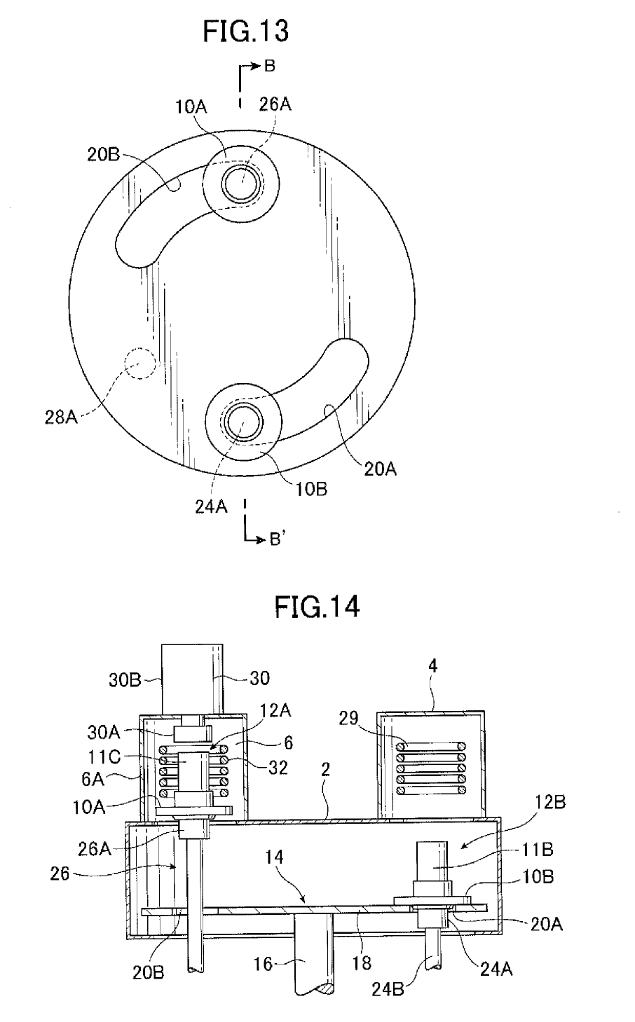

After the turntable 14 is turned until the one mold unit 12A is displaced to a position beneath the molding section 6, the one mold unit 12A is displaced from the position on the turntable 14 to an inside of the molding section 6 by the molding section displacement mechanism 26, as illustrated in FIGS. 13 and 14. In this way, the second displacement step S40 is completed. In the first embodiment, the second displacement step S40 corresponds to the sub-main displacement step of displacing the mold unit from the sub-operation section to the main operation section.

It is preferable to perform the second displacement step S40 when a temperature of the one mold unit 12A falls within the range equal to or above a temperature obtained by subtracting 50° C. from a glass-transition temperature of the glass material (Tg−50° C.) and equal to or below a value obtained by adding 10° C. to the glass-transition temperature (Tg+10° C.). In this embodiment, a temperature within the conveyance section 2 is maintained at about 200° C. When the one mold unit 12A is displaced from the inside of the preheating section 4 to the inside of the conveyance section 2 in the second displacement step S40, the temperature of the glass material is slightly reduced. For this reason, even if, at the start of the second displacement step S40, the glass material has a temperature of the glass-transition temperature+10° C., the temperature of the glass material becomes less than the glass-transition temperature Tg when it is displaced to the inside of the conveyance section 2 (see FIG. 17). Thus, during a time period of performing the second displacement step S40, the glass material has a temperature equal to or less than the glass-transition temperature, so that it becomes possible to prevent deformation of the glass material due to its own weight, etc. Further, the temperature of the one mold unit 12A is equal to or greater than a value obtained by subtracting 50° C. from the glass-transition temperature of the glass material, so that it becomes possible to shorten a heating time after the one mold unit 12A is displaced to the molding section 6. It is more preferable to perform the second displacement step S40 when the temperature of the one mold unit 12A falls within the range equal to or above a value obtained by subtracting 20° C. from the glass-transition temperature of the glass material (Tg−20° C.) and equal to or below the glass-transition temperature Tg. This makes it possible to more reliably prevent deformation of the glass material due to its own weight, etc., and further shorten the heating time after the one mold unit 12A is displaced to the molding section 6.

Then, as illustrated in FIG. 14, the heating step S51 of the pressing step S50 is performed to the one mold unit 12A to in the molding section 6. Specifically, the one mold unit 12A is heated in the molding section by the heater 32, in such a manner that the temperature of the glass material disposed inside the mold 11C reaches a value corresponding to a glass viscosity of 10⁶ to 10¹¹ dPa·s. Preferably, the heating is performed until the temperature becomes greater than a deformation point Ts by about 10 to 30° C.

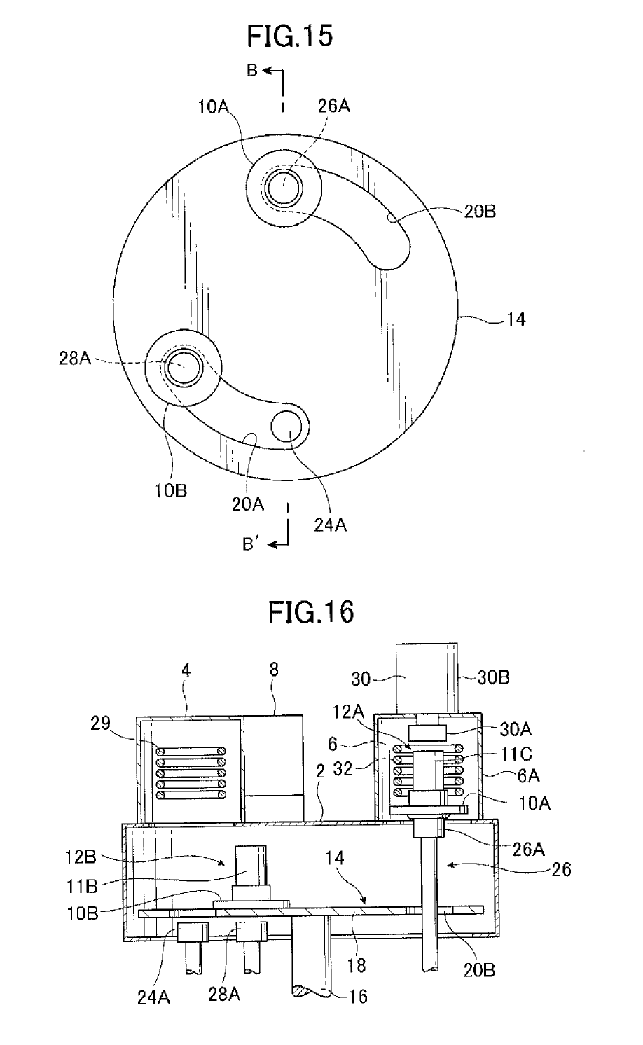

Concurrently with the operation of performing the heating step S51 of the pressing step S50 tot the one mold unit 12A, the turntable 14 is further turned in the clockwise direction by 60° until the other mold unit 12B is displaced to a position beneath the replacement section 8, as illustrated in FIGS. 15 and 16. In this operation, even in a situation where the one mold unit 12A is positioned inside the molding section 6 by the displacement mechanism 26, since the elongate hole 20B is formed in the turntable 14, the turntable 14 can be turned. Then, in this state, the glass material disposed inside the other mold unit 12B is slowly cooled inside the conveyance section 2. Subsequently, the other mold unit 12B is displaced from the position on the turntable 14 to the inside of the replacement section 8 by the displacement mechanism 28. In this way, the third displacement step S60 is completed.

After completion of the heating step S51 for the one mold unit 12A, the first pressing step S52 of the pressing step S50 is successively performed to the mold 11C of the one mold unit 12A in the molding section 6. Specifically, under a condition that the temperature of the glass material in the one mold unit 12A is maintained, the pressing head 30A is moved downwardly by the pressing head drive unit 30B to press the mold 11C in the up-down direction for a given time (e.g., several tens of seconds to several tens of minutes), thereby press molding the glass material. Preferably, a pressing load P1 in the first pressing step S52 is set in the range of 30 to 200 kgf/cm².

Then, heating of the mold 11C by the heater 32 is stopped or a heating temperature is reduced, to slowly cool the mold 11C and the glass material disposed therein (cooling step S53). Preferably, a cooling rate in the cooling step S53 is set in the range of 50 to 100° C./minute.

Then, after the temperature of the glass material disposed inside the mold 11C is reduced to about the glass-transition temperature Tg, the second pressing step S54 is performed. In the second pressing step S54, the mold 11C is pressed by the pressing machine 30, in the up-down direction for a given time (e.g., several tens of seconds to several tens of minutes), in the same manner as that in the first pressing step S52, and, in this state, the mold 11C and the glass material are slowly cooled. Preferably, a pressing load P2 in the second pressing step S54 is set to a value less than the pressing load P1 in the first pressing step S52, e.g., in the range of 10 to 40 kgf/cm².

Further, concurrently with the each steps (heating step S51, first pressing step S52, cooling step S53 and second pressing step S54) of the pressing step S50, the replacement step S10, the first displacement step S20 and the preheating step S30 are performed to the other mold unit 12B. These steps may be performed in the same manner as that described in regard to the one mold unit 12A, and detailed description thereof will be omitted here.

Then, after completion of the pressing step S50 for the one mold unit 12A, the third displacement step S60 of causing displacement from the molding section 6 to the replacement section 8 is performed to the one mold unit 12A. Concurrently, the second displacement step S40 of causing displacement from the preheating step 4 to the molding section 6 is performed to the other mold unit 12B. These steps may be performed in the same manner as the third displacement step S60 performed for the other mold unit 12B and the second displacement step S40 performed for the one mold unit 12A, and detailed description thereof will be omitted here.

It is preferable to perform the third displacement step S60 when the temperature of the glass material of the one mold unit 12A falls within the range equal to or above a value obtained by subtracting 100° C. from the glass-transition temperature of the glass material (Tg−100° C.) and equal to or below a value obtained by adding 10° C. to the glass-transition temperature (Tg+10° C.). More preferably, the temperature is in the range from (Tg−80° C.) to (Tg−10° C.). By starting the third displacement step S60 at a temperature equal to or less than a value obtained by adding 10° C. to the glass-transition temperature, when the one mold unit 12A is displaced from the molding section 6 to the conveyance section 2, the temperature of the glass material is reduced to a value equal to or less than the glass-transition temperature Tg. This makes it possible to prevent deformation of a glass molding due to its own weight, and shorten a pressing time.

The third displacement step S60 corresponds to the main-sub displacement step of displacement the mold unit from the main operation section to the sub-operation section.

By repeating the above steps, manufacture glass moldings can be performed repeatedly in parallel, with a timing delay, using in the pair of mold units 12A, 12B. The mold 11C detached in the replacement step may be sufficiently cooled in an outside of the apparatus.

As described above, in the lens molding apparatus 1 according to the first embodiment, the arc-shaped elongate holes 20A, 20B are formed in the turntable 14, so that, even when the molding section displacement mechanism 26 positions the one mold unit 12A inside the molding section 6, the turntable 14 can be turned.

Thus, during performing the pressing step to the other mold unit 12B in the molding section 6, the turntable 14 can displace the one mold unit 12A between the replacement section 8 and the preheating section 4. Therefore, during performing the pressing step to the other mold unit 12B, it is possible to replacement and preheating to the one mold unit 12A, so that it becomes possible to effectively utilize the replacement section 8, the preheating section 4 and the mold 11, thereby productivity being enhanced.

In this embodiment, the elongate holes 20A, 20B formed in the turntable 14 are formed over an angular width equal to an angular width between the preheating section 4 and the replacement section 8 about the rotary shaft of the turntable 14. Thus, even when the molding section displacement mechanism 26 positions the other mold unit 12B inside the molding section, the turntable 14 can be turned between the preheating section 4 and the replacement section 8.

In this embodiment, during performing the press step to the glass material disposed inside the one mold unit 12A, the replacement step, the first displacement step and the preheating step are concurrently performed to the other mold unit 12B. This makes it possible to eliminate a waiting time of the other mold unit 12B, thereby productivity being enhanced.

Although, in this embodiment, elongate holes are formed about the rotary shaft over the angular range between the replacement section 8 and the preheating section 4, it may be formed over an angular range greater than the angular range between the replacement section 8 and the preheating section 4, for example.

In this embodiment, the preheating section 4 and the molding section 6 are disposed, respectively, on radially opposite sides with respect to the rotary shaft, and the replacement section 8 is provided at a position apart from the preheating section 4 in the clockwise direction by 60°, these chambers may be provided at any other suitable positions apart from each other in the circumferential direction.

Although, by forming elongate holes in the turntable, the turntable 14 can be turned in the situation where the other mold unit 12B is positioned inside the molding section 6 by the molding section displacement mechanism 26 in the first embodiment, however the present invention is not limited thereto, and an arm or the like for displacing the mold unit on the turntable 14 and between the preheating section 4 and the replacement section 8 may be provided. That is, the present invention includes any configuration capable of conveying another mold support member between the preheating section 4 and the replacement section 8, in a situation where one of a plurality of displacement mechanisms position the one mold support member inside the molding section 6.

Although the replacement section and the preheating section are provided separately in this embodiment, the replacement section and the preheating section in the present invention is not limited thereto, but may be formed as an integral structure. Such a configuration will be described below, as a second embodiment of the present invention.

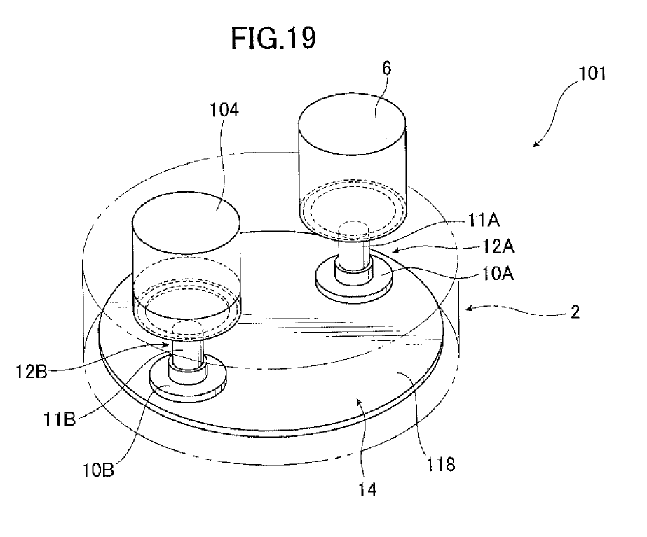

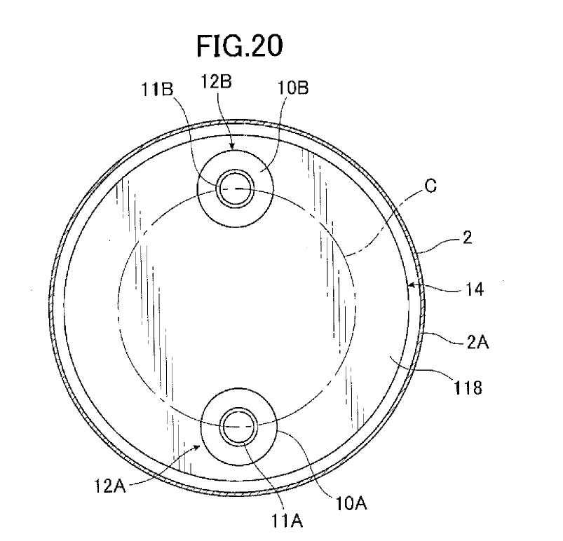

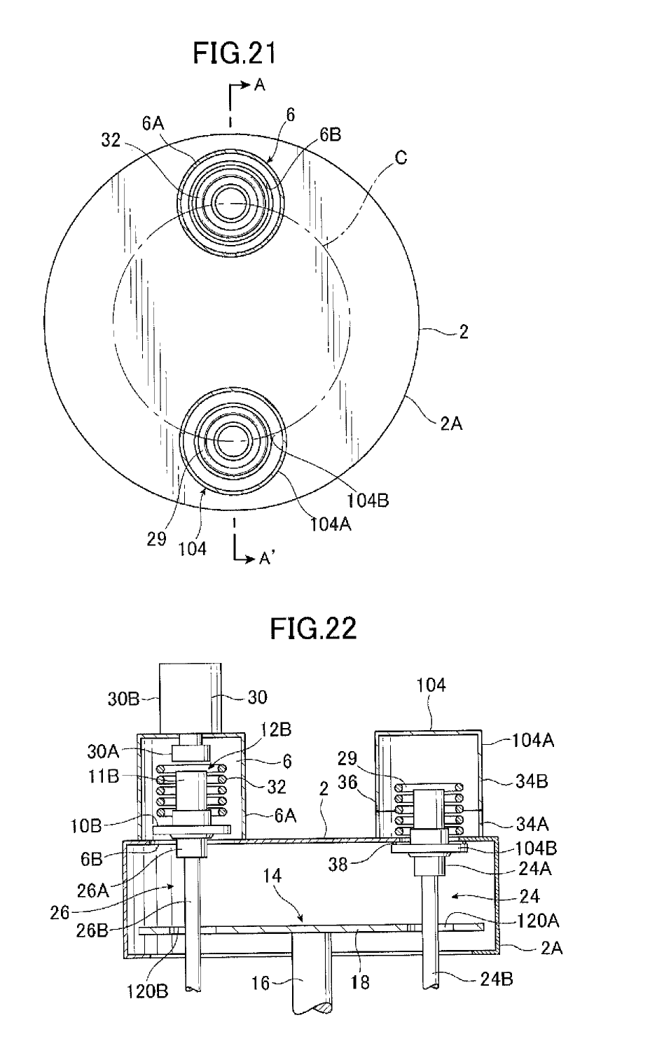

FIGS. 19 to 22 illustrates a configuration of a glass molding apparatus according to the second embodiment, wherein FIG. 19 is a perspective schematic view, and FIG. 20 is a horizontal sectional view at a height position of a conveyance section, FIG. 21 is a horizontal sectional view at a height position of a preheating and replacement section and a molding section, and FIG. 22 is a sectional view taken along the line A-A′ in FIG. 21. As illustrated in these figures, the lens molding apparatus according to the second embodiment comprises an approximately columnar-shaped conveyance section 2, a preheating and replacement section 104 composing a sub-operation section provided above the conveyance section 2, and a molding section 6 composing a main operation section provided above the conveyance section 2.

The preheating and replacement section 104 and the molding section 6 are arranged along a circumference of a small circle C having a given radius less than an outer radius of a turning disk 118 of the turntable 14. The preheating and replacement section 104 and the molding section 6 are provided on approximately radially opposite sides with respect to a rotary shaft of the turntable 14.

A columnar-shaped space is define by the conveyance section casing 2A and the conveyance section 2 comprises a turntable 14 installed in this space; and two displacement mechanisms 24, 26. Openings 104B, 6B are formed on the upper wall of the conveyance section casing 2A at respective areas corresponding to the preheating and replacement section 104 and the molding section 6. The space within the conveyance section 2 communicates with the internal spaces of the preheating and replacement section 104 and the molding section 6 via the openings 104B, 6B. In this embodiment, the opening 6B formed between the conveyance section 2 and the molding section 6 has a diameter greater than the diameter of the mold support members 10A, 10B. The opening 104B formed between the conveyance section 2 and the preheating and replacement section 104 has a diameter less than the diameter of each of the mold support members 10A, 10B.

A pair of circular openings 120A, 120B are provided to the turntable 14 on approximately radially opposite sides with respect to the rotary shaft 16 in this embodiment. These openings 120A, 120B are formed so as to be located on the circumference of the small circle C around the rotary shaft 16. The preheating and replacement section 104 and the molding section 6 are formed above the conveyance section 2, along the circumference of the small circle C passing through centers of the openings 120A, 120B.

The preheating section displacement mechanism 24 and the molding section displacement mechanism 26 are provided beneath the preheating and replacement section 104 and the molding section 6, respectively.

The preheating and replacement section 104 is formed of an approximately circular cylindrical-shaped space defined by a replacement section casing 104A, and comprises a heater 29 provided therein. The replacement section casing 104A comprises a base casing 34A integrated with an upper portion of the conveyance section casing 2A, and an upper casing 34B disposed above the base casing 34A. An O-ring 36 is attached to an upper edge face of the base casing 34A. An O-ring 38 is also attached to a region of the upper wall of the conveyance section casing 2A surrounding the opening 104B corresponding to the preheating and replacement section 104.

In the second embodiment, the molding section 6 comprises the main operation section” for subjecting the glass material disposed inside the mold unit to press molding. Further, the preheating and replacement section 104 comprises the sub-operation section for performing replacement between the mold unit after completion of the press molding and a new mold unit, and heating of the glass material disposed inside the new mold unit. The molding section displacement mechanism 26 comprises the main displacement mechanism and the preheating section displacement mechanism 24 comprises the sub-displacement mechanism.

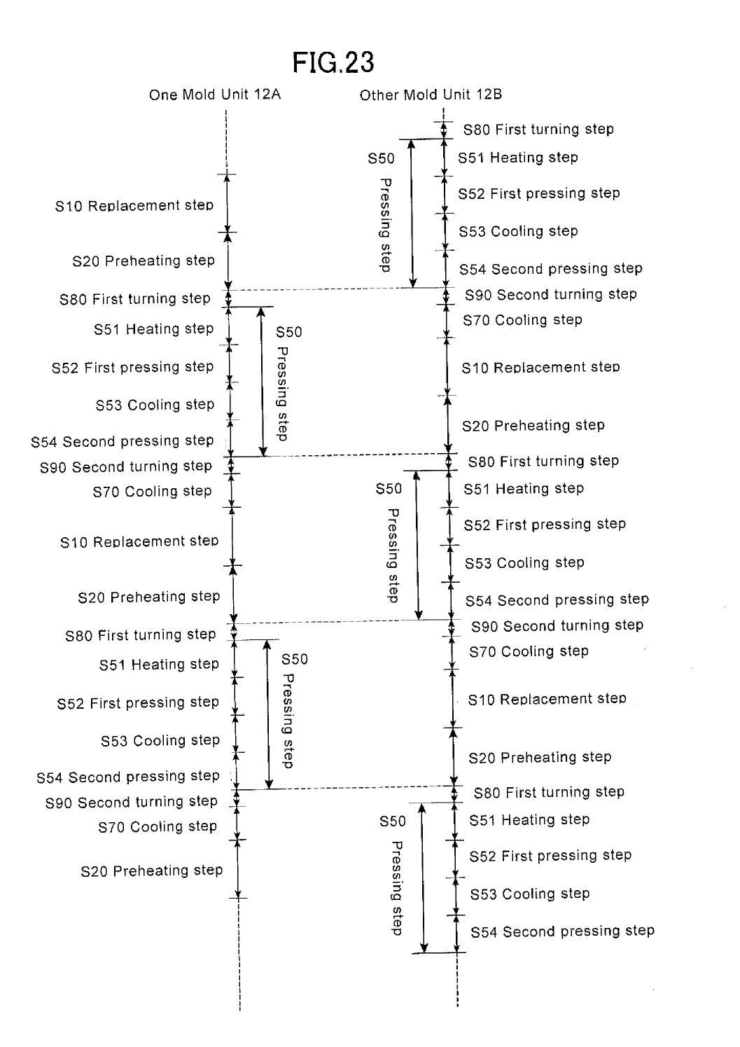

FIG. 23 is a chart presenting a flow of a process to be performed with respect to a pair of mold units 12A, 12B. With reference to FIG. 23, a lens molding method using the above lens molding apparatus 101 will be described below.

The following description will be started from a state just after the one mold unit 12A is positioned within the preheating and replacement section 104 with completion of molding of the glass material disposed inside the one mold 11A of the one mold unit 12A, and the other mold unit 12B is held inside the molding section 6 by the displacement mechanism 28 and the heating step in the press step is started.

First of all, in this state, the replacement step is performed to the one mold unit 12A. Specifically, the upper casing 34B of the preheating and replacement section 104 is displaced upwardly, and a mold 11A after completion of the molding is detached from the one mold support member 10A. Then, a mold 11C in which a new glass material disposed is attached to the one mold support member 10A, and the upper casing 34B is placed on the base casing 34A again.

Then, following the replacement step for the one mold unit 12A, a preheating step is performed to the one mold unit 12A. Specifically, the mold 11C is heated by the heater 29 in the preheating and replacement section 104.

Concurrently with the above replacement step and preheating step, a pressing step consisting of a heating step, a first pressing step, a cooling step and a second pressing step is performed to the other mold unit 12B.

Then, a first turning step of displacing from the preheating and replacement section 104 to the molding section 6 is performed to the one mold unit 12A, and, concurrently a second turning step of displacing from the molding section 6 to the preheating and replacement section 104 is performed to the other mold unit 12B.

Specifically, the one mold unit 12A is displaced from the inside of the preheating and replacement section 104 to a position on the turntable 14 by the preheating section displacement mechanism 24, while the other mold unit 12B is displaced from the molding section 6 to a position on the turntable 14 by the molding section displacement mechanism 26. Then, the turntable 14 is turned by 180° until the one mold unit 12A is displaced to a position beneath the molding section 6, and the other mold unit 12B is displaced to a position beneath the preheating and replacement section 104. Then, the one mold unit 12A is displaced from the position on the turntable 14 to an inside of the molding section 6 by the preheating section displacement mechanism 24, and concurrently the other mold unit 12B is displaced from the position on the turntable 14 to an inside of the preheating and replacement section 104 by the molding section displacement mechanism 26.

It is preferable to perform the first displacement step when a temperature of the one mold unit 12A falls within the range equal to or above a value obtained by subtracting 50° C. from a glass-transition temperature of the glass material (Tg−50° C.) and equal to or below a value obtained by adding 10° C. to the glass-transition temperature (Tg+10° C.), similarly to the first embodiment. Further, it is preferable to perform the second displacement step when the temperature of the one old unit 12A falls within the range equal to or above a value obtained by subtracting 100° C. from the glass-transition temperature of the glass material (Tg−100° C.) and equal to or below a value obtained by adding 10° C. to the glass-transition temperature (Tg+10° C.), similarly to the first embodiment.

Then, a molding step is performed to the one mold unit 12A, and concurrently with this a cooling step, a replacement step and a preheating step are performed to the other mold unit 12B. In the molding step, the heating step, the first pressing step, the cooling step and the second pressing step may be performed in this order in the same manner as that in the first embodiment. The cooling step may be performed in the same manner as that in the first embodiment, and the replacement step and the preheating step may be performed in the same manner as that for the one mold unit 12A.

Then, the second turning step is performed to the one mold unit 12A, and concurrently with this, the first turning step is performed to the other mold unit 12B. The method for performing second turning step and the first turning step may be concurrently performed in the same manner as performing the second turning step to the other mold unit 12B and concurrently performing the first turning step to the one mold unit 12A.

By repeating the above steps, manufacture glass moldings can be performed repeatedly in parallel, with a timing delay, using in the pair of mold units.

As described above, in this embodiment, the preheating section and the replacement section is formed as an integral structure, so that, while the pressing step (molding step) is performed to the one mold unit 12A of a pair of mold units, the replacement step and the preheating step is performed the other mold unit 12B in parallel with this, thereby productivity being enhanced.

Although each of the preheating section 4, the molding section 6, the replacement section 8 and the preheating and replacement section 104 are provided above the conveyance section 2 in these embodiments, the present invention is not limited thereto, but these sections may be provided on the side of an outer periphery of or beneath the conveyance section 2. For example, in the case where the conveyance section 2 is provided on outer periphery of the preheating section 4, the molding section 6, the replacement section 8 and the preheating and replacement section 104, a circumferential groove in the turning disk 18 of the turntable 14 may be provided and a device configured to extend a drive shaft through the groove to thereby displace the drive shaft along the groove while holding the mold unit (12A, 12B) may be employed as the displacement mechanism. Alternatively, as the displacement mechanism, it is possible to employ an arm or the like capable of being advanced and retracted from a center of the turntable 14 toward each of the preheating section 4, the molding section 6, the replacement section 8 and the preheating and replacement section 104, while holding the mold units 12A, 12B.

Although the replacement step in these embodiments is configured such that the mold 11A after completion of the press molding is detached from the one mold support member 10A, and a mold 11C having a new glass material disposed thereinside is attached to the one mold support member 10A, the replacement step in the present invention is not limited thereto, but may be configured such that the mold 11A after completion of the press molding is detached from the one mold support member 10A, a new glass material is disposed inside the detached mold 11A, and the mold 11A is re-attached to the one mold support member 10A.

Although the lens molding apparatus in the above embodiments is configured such that the molds 11A, 11B, 11C are attached to the mold support member 10A, 10B, and the mold support members 10A, 10B are displaced by the displacement mechanism 24, 26, 28 and the turntable 18, the present invention is not limited thereto, but may be configured to displace the mold unit 12A, 12B directly by the displacement mechanism 24, 26, 28 and the turntable 18, without the mold support member 10A, 10B. That is, the mold unit 12A, 12B may comprise at least the mold 11A, 11B, 11C.

Last of all, the first and second embodiments will be outlined using the figures and others.

As illustrated in FIG. 1, apparatus 1 for molding the lens of the glass molding according to the first embodiment relates to a glass molding manufacturing apparatus for manufacturing a glass molding by heating a glass material disposed inside a mold unit 12A, 12B and press molding the heated glass material, comprising: a conveyance section 2 having a turntable 14 holding the mold unit 12A, 12B and turning; a molding section 6 for performing at least press molding to the glass material disposed inside the mold unit 12A, 12B; a replacement section 8 for performing replacement between the mold unit after completion of the press molding and a new mold unit 12A, 12B; and a preheating section 4 for performing an operation including heating of the glass material disposed inside the new mold unit 12A, 12B, wherein the molding section 6, the replacement section 8 and the preheating section 4 are provided in adjacent relation to the conveyance section 2 at respective positions apart from each other in a circumferential direction about a rotary shaft of the turntable 14, and wherein the lens molding apparatus 1 further comprises: a molding section displacement mechanism 26 for displacing the mold unit 12A, 12B between the molding section 6 and the conveyance section 2; and a replacement section displacement mechanism 28 and a preheating section displacement mechanism 24 for displacing the mold unit 12A, 12B between the replacement section 8 and the preheating section 4, and the conveyance section 2.

Preferably, in the above apparatus 1 for molding the lens of the glass molding, the molding section 6, the preheating section 4 and the replacement section 8 are arranged above the conveyance section 2, along a circumference of a small circle having a radius less than a radius of the turntable 14.

More preferably, in the above apparatus I for molding the lens of the glass molding, the molding section displacement mechanism 26 has a first drive shaft for displacing the mold unit 12A, 12B between the conveyance section 2 and the molding section 6 in an up-down direction; the preheating section displacement mechanism 24 has a second drive shaft for displacing the mold unit 12A, 12B between the conveyance section 2 and the preheating section 4 in the up-down direction; and the replacement section displacement mechanism 28 has a third drive shaft for displacing the mold unit 12A, 12B between the conveyance section 2 and the replacement section 8 in the up-down direction, wherein a plurality of openings 4B, 6B, 8B are formed in the turntable 14, and wherein the plurality of openings 4B, 6B, 8B are formed in a shape which allows the turntable 14 to be turned by at least an angular width between the preheating section 4 and the replacement section 8, in a situation where the first drive shaft is penetratingly inserted in one of the plurality of openings 4B, 6B, 8B.

More preferably, in the above apparatus 1 for molding the lens of the glass molding, each of the openings 4B, 6B, 8B is formed to extend in an arc pattern, about the rotary shaft of the turntable 14 and along the circumference of the small circle C, over an angular width equal to the angular width between the preheating section 4 and the replacement section 8.

Preferably, in the above apparatus 1 for molding the lens of the glass molding, the mold unit 12A, 12B has a mold 12 having a molding surface corresponding to a shape of the glass molding, and a mold support member 11 for holding the mold 12.

As illustrated in FIG. 18, the glass molding manufacturing method according to the first embodiment relates to a glass molding manufacturing method using the apparatus 1 for molding the lens of the glass molding, wherein the apparatus 1 for molding the lens of the glass molding comprises: a conveyance section 2 housing a turntable 14; a molding section 6 for press molding a glass material disposed inside a mold unit 12A, 12B; a replacement section 8 for performing replacement of the mold unit 12A, 12B having a glass material disposed thereinside; and a preheating section 4 for performing heating of the glass material disposed inside the mold unit 12A, 12B, wherein the molding section 6, the replacement section 8 and the preheating section 4 are provided in adjacent relation to the conveyance section 2 at respective positions apart from each other in a circumferential direction about a rotary shaft of the turntable 14, and wherein the apparatus 1 for molding the lens of the glass molding further comprises: a molding section displacement mechanism 26 for displacing the mold unit 12A, 12B between the molding section 6 and the conveyance section 2; and a replacement section displacement mechanism 28 and a preheating section displacement mechanism 24 for displacing the mold unit 12A, 12B between the replacement section 8 and the preheating section 4, and the conveyance section 2, the method comprising: a replacement step of performing by the replacement section 8 the replacement of the mold unit 12A, 12B; a preheating step of preheating by the preheating section 4 the glass material disposed inside the mold unit 12A, 12B; a sub-main displacement step of: displacing by the preheating section displacement mechanism 24 the mold unit 12A, 12B from the preheating section 4 to the conveyance section 2; turningly displacing by the turntable 14 the mold unit through the conveyance section 2; and displacing by the molding section displacement mechanism 26 the mold unit from the conveyance section 2 to the molding section 6; a molding step of press molding the glass material by the molding section 6; and a main-sub displacement step of; displacing by the molding section displacement mechanism 26 the mold unit 12A, 12B from the molding section 6 to the conveyance section 2; turningly displacing by the turntable 14 the mold unit through the conveyance section 2; and displacing by the replacement section displacement mechanism 28 the mold unit from the conveyance section 2 to the replacement section 8, wherein, while the molding step is performed to one mold unit 12A is subjected to the molding step, at least a part of one of the replacement step and the preheating step is concurrently performed.

As illustrated in FIG. 19, the apparatus 101 for molding lens of glass molding according to the second embodiment relates to a glass molding manufacturing apparatus for manufacturing a glass molding by heating a glass material disposed inside a mold unit 12A, 12B and press molding the heated glass material, comprising: a conveyance section 2 having a turntable 14 turning with holding the mold unit 12A, 12B; a molding section 6 for performing at least press molding to the glass material disposed inside the mold unit 12A, 12B; a preheating and replacement section 104 for performing replacement between the mold unit 12A, 12B after completion of the press molding and a new mold unit, and heating of the glass material disposed inside the new mold unit 12A, 12B, wherein the molding section 6 and the preheating and replacement section 104 are provided in adjacent relation to the conveyance section 2 at respective positions apart from each other in a circumferential direction about a rotary shaft of the turntable 14, and wherein the apparatus 101 for molding lens of glass molding further comprises: a molding section displacement mechanism 26 for displacing the mold unit 12A, 12B between the molding section 6 and the conveyance section 2; and a replacement section displacement mechanism 28 and a preheating section displacement mechanism 24 for displacing the mold unit 12A, 12B between the preheating and replacement section 104 and the conveyance section 2.

As illustrated in FIGS. 19 and 23, the glass molding manufacturing method for use in the second embodiment relates to a glass molding manufacturing method using the apparatus 101 for molding lens of glass molding, wherein the apparatus 101 for molding lens of glass molding comprises: a conveyance section 2 housing a turnable turntable 14; a molding section 6 for press molding a glass material disposed inside a mold unit 12A, 12B; and a preheating and replacement section 104 for performing replacement of the mold unit 12A, 12B having a glass material disposed thereinside and heating of the glass material disposed inside the mold unit 12A, 12B, wherein the molding section 6 and the preheating and replacement section 104 are provided in adjacent relation to the conveyance section 2 at respective positions apart from each other in a circumferential direction about a rotary shaft of the turntable 14, and wherein the apparatus 101 for molding lens of glass molding further comprises: a molding section displacement mechanism 26 for displacing the mold unit 12A, 12B between the molding section 6 and the conveyance section 2; and a preheating section displacement mechanism 24 for displacing the mold unit 12A, 12B between the preheating and replacement section 104 and the conveyance section 2, the method comprising: a replacement step of performing by the preheating and replacement section 104 the replacement of the mold unit 12A, 12B; a preheating step of preheating by the preheating and replacement section 104 the glass material disposed inside the mold unit 12A, 12B; a sub-main displacement step of: displacing by the preheating section displacement mechanism 24 the mold unit 12A, 12B from the preheating and replacement section 104 to the conveyance section 2; turningly displacing by the turntable 14 the mold unit through the conveyance section 2; and displacing by the molding section displacement mechanism 26 the mold unit from the conveyance section 2 to the molding section 6; a molding step of press molding the glass material by the molding section 6; and a main-sub displacement step of: displacing by the molding section displacement mechanism 26 the mold unit 12A, 12B from the molding section 6 to the conveyance section 2; turningly displacing by the turntable 14 the mold unit through the conveyance section 2; and displacing by the preheating section displacement mechanism 24 the mold unit from the conveyance section 2 to the preheating and replacement section 104, wherein, while the molding step is performed to one mold unit 12A, at least a part of one of the replacement step and the preheating step is concurrently performed to another mold unit (12B).

### LIST OF NUMERICAL REFERENCES

1, 101: lens molding apparatus
2: conveyance section
4: preheating section
6: molding section
8: replacement section
10A, 10B: mold support member
11A, 11B, 11C: mold
12A, 12B: mold unit
13A: upper mold
138: the lower mold
3C: sleeve mold
14: turntable
15: glass material
16: rotary shaft
18: turning disk
20A, 20B: elongate hole
24, 26, 28: displacement mechanism
24A, 26B, 28B: drive shaft
29, 32: heater
30: pressing machine

1. An apparatus for manufacturing a glass molding by heating a glass material disposed inside a mold unit and press molding the heated glass material, comprising:
a conveyance section including a turntable turning with holding the mold unit;
a main operation section for performing at least press molding the glass material disposed inside the mold; and
a sub-operation section for performing an operation which is different from that in the main operation section and includes replacement between the mold unit after completion of the press molding and a new mold unit, or replacement between a glass molding molded from the mold unit after completion of the press molding and a glass material, and heating of the glass material disposed inside the new mold unit,
wherein the main operation section and the sub-operation section are provided in adjacent relation to the conveyance section at respective positions apart from each other in a circumferential direction about a rotary shaft of the turntable, and
wherein the glass molding manufacturing apparatus further comprises: a main displacement mechanism for displacing the mold unit between the main operation section and the conveyance section; and a sub-displacement mechanism for displacing the mold unit between the sub-operation section and the conveyance section.

2. The apparatus for manufacturing a glass molding according to claim 1, wherein:
the main operation section includes a molding section for performing at least press molding the glass material disposed inside the mold unit;
the sub-operation section includes
a preheating section for performing heating of the glass material disposed inside the mold unit, and
a replacement section for performing the replacement between the mold unit after completion of the press molding and a new mold unit, or replacement between a glass molding molded from the mold unit after completion of the press molding and a glass material;
the main displacement mechanism includes a molding section displacement mechanism for displacing the mold unit between the main operation section and the conveyance section; and
the sub-displacement mechanism includes
a preheating section displacement mechanism for displacing the mold unit between the preheating section and the conveyance section, and
a replacement section displacement mechanism for displacing the mold unit between the replacement section and the conveyance section,
and wherein the turntable is turnable independently of the molding section displacement mechanism, in a situation where the molding section displacement mechanism positions the mold unit inside the main operation section.

3. The apparatus for manufacturing a glass molding according to claim 2, wherein the molding section, the preheating section and the replacement section are arranged above the conveyance section, along a circumference of a small circle having a radius less than a radius of the turntable.

4. The apparatus for manufacturing a glass molding according to claim 3, wherein:
the molding section displacement mechanism has a first drive shaft for displacing the mold unit between the conveyance section and the molding section in an up-down direction;
the preheating section displacement mechanism has a second drive shaft for displacing the mold unit between the conveyance section and the preheating section in the up-down direction;
the replacement section displacement mechanism has a third drive shaft for displacing the mold unit between the conveyance section and the replacement section in the up-down direction, and
wherein a plurality of openings is formed in the turntable, the plurality of openings being formed in a shape which allows the turntable to be turned by at least an angular width between the preheating section and the replacement section, in a situation where the first drive shaft is inserted into one of the plurality of openings.

5. The apparatus for manufacturing a glass molding according to claim 4, wherein the openings are formed to extend in an arc pattern, about the rotary shaft of the turntable and along the circumference of the small circle, over an angular width equal to the angular width between the preheating section and the replacement section.

6. The apparatus for manufacturing a glass molding according to claim 1, wherein the main operation section comprises a heating device for heating and softening the glass material disposed inside the mold unit, and a pressing device for pressing the mold unit, thereby press molding the glass material.

7. The apparatus for manufacturing a glass molding according to claim 1, wherein the mold unit comprises: a mold having a molding surface corresponding to a shape of the glass molding; and a mold support member for holding the mold.

8. A method for manufacturing glass molding using a glass molding manufacturing apparatus,
wherein the glass molding manufacturing apparatus comprises: a conveyance section housing a turntable; a main operation section for press molding a glass material disposed inside a mold unit; and a sub-operation section for performing an operation which is different from that in the main operation section and includes replacement between the mold unit after completion of the press molding and a new mold unit, or replacement between a glass molding molded from the mold unit after completion of the press molding and a glass material, and heating of the glass material disposed inside the new mold unit,
wherein the main operation section and the sub-operation section are provided in adjacent relation to the conveyance section at respective positions apart from each other in a circumferential direction about a rotary shaft of the turntable, and
wherein the glass molding manufacturing apparatus further comprises: a main displacement mechanism for displacing the mold unit between the main operation section and the conveyance section; and a sub-displacement mechanism for displacing the mold unit between the sub-operation section and the conveyance section,
the method comprising:
a replacement step of performing by the sub-operation section the replacement between the mold unit after completion of the press molding and a new mold unit, or the replacement between a glass molding molded from the mold unit after completion of the press molding and a glass material;
a preheating step of preheating by the sub-operation section the glass material disposed inside the mold unit;
a sub-main displacement step of displacing by the sub-displacement mechanism the mold unit from the sub-operation section to the conveyance section; turningly displacing by the turntable the mold unit through the conveyance section; and displacing by the main displacement mechanism the mold unit from the conveyance section to the main operation section;
a molding step of press molding the glass material by the main-operation section; and
a main-sub displacement step of: displacing by the main displacement mechanism the mold unit from the main operation section to the conveyance section;
turningly displacing by the turntable the mold unit through the conveyance section; and
displacing by the sub-displacement mechanism the mold unit from the conveyance section to the sub-operation section,
wherein, while the molding step is performed to one mold unit, at least a part of one of the replacement step and the preheating step is concurrently performed to another mold unit.

9. The method for manufacturing glass molding according to claim 8, wherein:
the main operation section includes a molding section for performing at least press molding to the glass material disposed inside the mold unit;
the sub-operation section includes
a preheating section for performing heating of the glass material disposed inside the mold unit, and
a replacement section for performing the replacement between the mold unit after completion of the press molding and a new mold unit, or replacement between a glass molding molded from the mold unit after completion of the press molding and a glass material;
the main displacement mechanism includes a molding section displacement mechanism for displacing the mold unit between the main operation section and the conveyance section; and
the sub-displacement mechanism includes
a preheating section displacement mechanism for displacing the mold unit between the preheating section and the conveyance section, and
a replacement section displacement mechanism for displacing the mold unit between the replacement section and the conveyance section,
wherein the replacement step is performed by the replacement section;
wherein the preheating step is performed by the preheating section;
wherein, in the sub-main displacement step, the mold unit is displaced by the preheat section displacement mechanism from the preheating section to the conveyance section; turningly displaced by the turntable through the conveyance section; and displaced by the molding section displacement mechanism from the conveyance section to the molding section; and
wherein, in the main-sub displacement step, the mold unit is displaced by the molding section displacement mechanism from the molding section to the conveyance section; turningly displaced by the turntable through the conveyance section; and displaced by the replacement section displacement mechanism from the conveyance section to the replacement section,
wherein the method further comprises, between the replacement step and the preheating step, a sub-sub displacement step of: displacing by the replacement section displacement mechanism the mold unit from the replacement section to the conveyance section; turningly displacing by the turntable the mold unit through the conveyance section; and displacing by the preheating section displacement mechanism the mold unit from the conveyance section to the preheating section.

10. The method for manufacturing glass molding according to claim 9, wherein, while the one mold unit is subjected to the molding step, at least the replacement step, the sub-sub displacement step and the preheating step is concurrently performed.

11. The method for manufacturing glass molding according to claim 9, wherein, while the one mold unit is subjected to the sub-main displacement step, the main-sub displacement step is performed to another glass material.

12. The method for manufacturing glass molding according to claim 8, wherein the sub-main displacement step is performed when a temperature of the mold unit falls within the range equal to or above a value obtained by subtracting 50° C. from a glass-transition temperature of the glass material, and equal to or below a value obtained by adding 10° C. to the glass-transition temperature.

13. The method for manufacturing glass molding according to claim 8, wherein the maim-sub displacement step is performed when the temperature of the mold unit falls within the range equal to or above a value obtained by subtracting 100° C. from the glass-transition temperature of the glass material, and equal to or below a value obtained by adding 10° C. to the glass-transition temperature.
